(19) United States
(12) Patent Application Publication
(10) Pub. No.: US 2025/0012912 A1
(43) Pub. Date: Jan. 9, 2025

(54) INDICATING PUNCTURING PATTERNS

(71) Applicants: Qinghua Li, San Ramon, CA (US); Yonathan Segev, Sunnyvale, CA (US); Cheng Chen, Camas, WA (US); Shlomi Vituri, Tel Aviv (IL); Carlos Cordeiro, Portland, OR (US)

(72) Inventors: Qinghua Li, San Ramon, CA (US); Yonathan Segev, Sunnyvale, CA (US); Cheng Chen, Camas, WA (US); Shlomi Vituri, Tel Aviv (IL); Carlos Cordeiro, Portland, OR (US)

(21) Appl. No.: 18/896,471

(22) Filed: Sep. 25, 2024

Related U.S. Application Data
(60) Provisional application No. 63/585,782, filed on Sep. 27, 2023.

(51) Int. Cl. G01S 13/74

(52) U.S. Cl. CPC G01S 13/74

(57) ABSTRACT

Methods, apparatuses, and computer readable media for indicating puncturing patterns, where an ISTA comprises processing circuitry configured to: encode a FTMR frame including a first ranging parameters element, the first ranging parameters element comprising a first puncturing pattern support subfield, the first puncturing pattern support subfield indicating supported puncturing patterns, and including a first ranging parameter field including a first format and bandwidth subfield indicating a requested format and bandwidth for a FTM method on a 320 MHz bandwidth, and the processing circuitry configured to: decode, from an RSTA, an IFTM frame including a second ranging parameters element including a second puncturing pattern support subfield indicating the allocation of puncturing patterns, and including a second ranging parameters field including a second format and bandwidth subfield indicating an allocated format and bandwidth for the FTM method.

### PRIORITY CLAIM

This application claims the benefit of priority under 35 USC 119(e) to U.S. Provisional Patent Application Ser. No. 63/585,782, filed Sep. 27, 2023 [reference number AF6330-Z], which is incorporated herein by reference in its entirety.

### TECHNICAL FIELD

Embodiments relate to indicating puncturing patterns by an initial station (STA) and a responder STA in relation to performing ranging, in accordance with wireless local area networks (WLANs) and Wi-Fi networks including networks operating in accordance with different versions or generations of the IEEE 802.11 family of standards.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols on different bands and on different channels.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates a front-end module circuitry for use in the radio architecture of FIG. 1 in accordance with some embodiments;

FIG. 3 illustrates a radio IC circuitry for use in the radio architecture of FIG. 1 in accordance with some embodiments;

FIG. 4 illustrates a baseband processing circuitry for use in the radio architecture of FIG. 1 in accordance with some embodiments;

FIG. 5 illustrates a WLAN in accordance with some embodiments;

FIG. 6 illustrates a block diagram of an example machine upon which any one or more of the techniques (e.g., methodologies) discussed herein may perform;

FIG. 7 illustrates a block diagram of an example wireless device upon which any one or more of the techniques (e.g., methodologies or operations) discussed herein may perform;

FIG. 8 illustrates multi-link devices (MLD) s, in accordance with some embodiments;

FIG. 9 illustrates mandatory puncturing patterns, in accordance with some embodiments;

FIG. 10 illustrates the ranging parameters element, in accordance with some embodiments;

FIG. 11 illustrates a ranging parameters field, in accordance with some embodiments;

FIG. 12 illustrates a method for indicating puncturing patterns, in accordance with some embodiments;

FIG. 13 illustrates a method for indicating puncturing patterns, in accordance with some embodiments;

FIG. 14 illustrates a method for indicating puncturing patterns, in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth® (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth® (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM circuitry 104A and FEM circuitry 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband processing circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband processing circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.1bk, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth® (BT) connectivity standard such as Bluetooth®, Bluetooth® 4.0 or Bluetooth® 5.0, or any other iteration of the Bluetooth® Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about nine hundred MHz, 2.4 GHz, 5 GHZ, and bandwidths of about 1 MHZ, 2 MHZ, 2.5 MHz, 4 MHZ, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

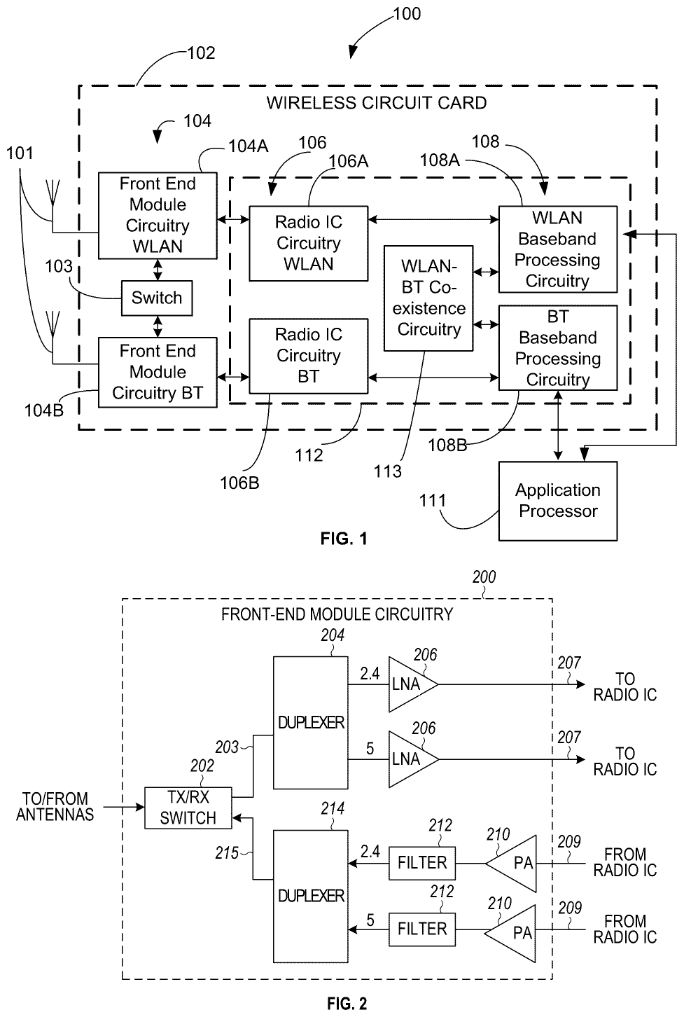

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

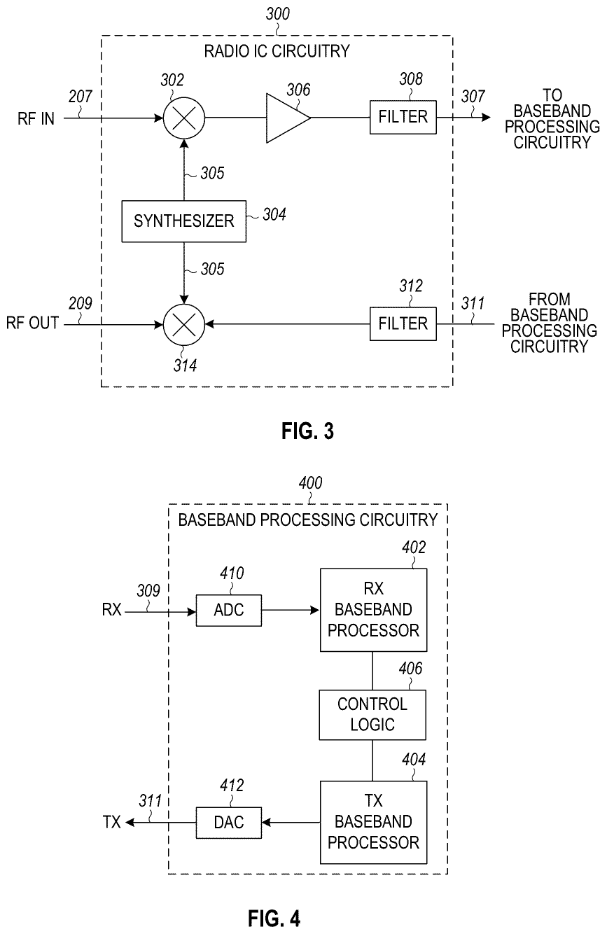

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 302 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (fLo) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (fLo).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the TX BBP 404 may be configured to generate OFDM or OFDMA signals as appropriate for transmission by performing an inverse fast Fourier transform (IFFT). The RX BBP 402 may be configured to process received OFDM signals or OFDMA signals by performing an FFT. In some embodiments, the RX BBP 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

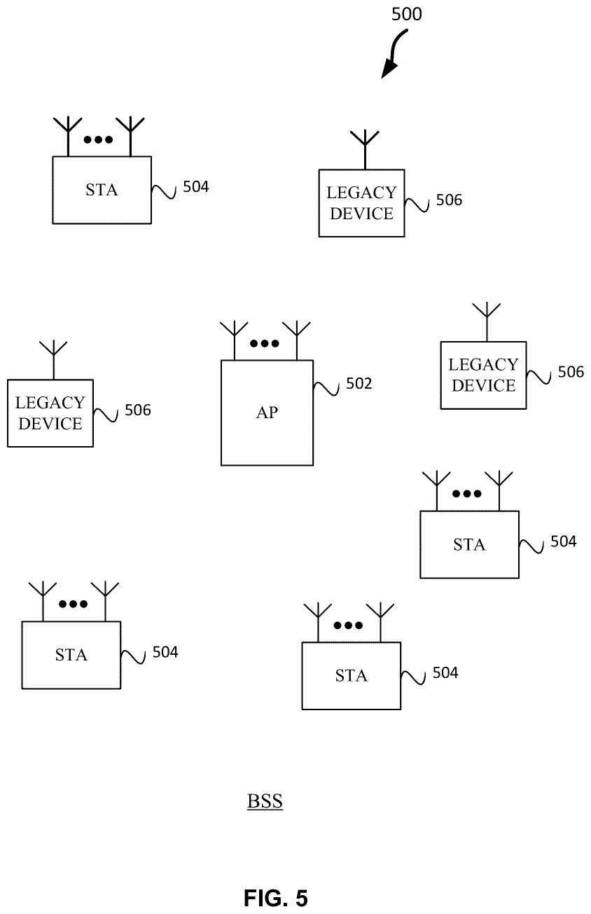

FIG. 5 illustrates a WLAN 500 in accordance with some embodiments. The WLAN 500 may comprise a basis service set (BSS) that may include an access point (AP) AP 502, a plurality of stations (STAs) STAs 504, and a plurality of legacy devices 506. In some embodiments, the STAs 504 and/or AP 502 are configured to operate in accordance with IEEE 802.11be extremely high throughput (EHT), WiFi 8 IEEE 802.11 ultra-high throughput (UHT), high efficiency (HE) IEEE 802.11ax, IEEE 802.11bn next generation or ultra-high reliability (UHR), IEEE 802.11bk, and/or another IEEE 802.11 wireless communication standard. In some embodiments, the STAs 504 and/or AP 502 are configured to operate in accordance with IEEE P802.11be, and/or IEEE P802.11-REVme™, both of which are hereby included by reference in their entirety.

The AP 502 may use other communications protocols as well as the IEEE 802.11 protocol. The terms here may be termed differently in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502 and may control more than one BSS, e.g., assign primary channels, colors, etc. AP 502 may be connected to the internet.

The legacy devices 506 may operate in accordance with one or more of IEEE 802.11 a/b/g/n/ac/ad/af/ah/aj/ay/ax/uht, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques. In example embodiments, the AP 502 may also be configured to communicate with STAs 504 in accordance with legacy IEEE 802.11 communication techniques.

In some embodiments, a HE, EHT, UHT frames may be configurable to have the same bandwidth as a channel. The HE, EHT, UHT frame may be a physical Layer Convergence Procedure (PLCP) Protocol Data Unit (PPDU). In some embodiments, PPDU may be an abbreviation for physical layer protocol data unit (PPDU). In some embodiments, there may be different types of PPDUs that may have different fields and different physical layers and/or different media access control (MAC) layers. For example, a single user (SU) PPDU, downlink (DL) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80 MHZ, 80+80 MHz, 160 MHz, 160+160 MHz, 320 MHz, 320+320 MHz, 640 MHz bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHZ, 80 MHZ, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHZ, 160 MHz and 80+80 MHz OFDMA and MU-MIMO HE PPDU formats. In some embodiments, the 996-subcarrier RU is used in the 160 MHz and 80+80 MHZ OFDMA and MU-MIMO HE PPDU formats.

A HE, EHT, UHT, UHT, or UHR frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, low-power Bluetooth®, or other technologies.

In accordance with some IEEE 802.11 embodiments, e.g., IEEE 802.11EHT/ax/be embodiments, a HE AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE, EHT, UHR control period, the AP 502 may communicate with STAs 504 using one or more HE or EHT frames. During the TXOP, the HE STAs 504 may operate on a sub-channel smaller than the operating range of the AP 502. During the TXOP, legacy stations refrain from communicating. The legacy stations may need to receive the communication from the HE AP 502 to defer from communicating.

In accordance with some embodiments, during the TXOP the STAs 504 may contend for the wireless medium with the legacy devices 506 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or STAs 504 in accordance with legacy IEEE 802.11 communication techniques. In some embodiments, the AP 502 may also be configurable to communicate with STAs 504 outside the TXOP in accordance with legacy IEEE 802.11 or IEEE 802.11EHT/UHR communication techniques, although this is not a requirement.

In some embodiments the STA 504 may be a “group owner” (GO) for peer-to-peer modes of operation. A wireless device may be a STA 504 or a HE AP 502. The STA 504 may be termed a non-access point (AP) (non-AP) STA 504, in accordance with some embodiments.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the HE STA 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-14.

In example embodiments, the STAs 504 and/or the AP 502 are configured to perform the methods and operations/functions described herein in conjunction with FIGS. 1-14. In example embodiments, an apparatus of the STA 504 and/or an apparatus of the AP 502 are configured to perform the methods and functions described herein in conjunction with FIGS. 1-14. The term Wi-Fi may refer to one or more of the IEEE 802.11 communication standards. AP and STA may refer to EHT/HE access point and/or EHT/HE station as well as legacy devices 506.

In some embodiments, a HE AP STA may refer to an AP 502 and/or STAs 504 that are operating as EHT APs 502. In some embodiments, when a STA 504 is not operating as an AP, it may be referred to as a non-AP STA or non-AP. In some embodiments, STA 504 may be referred to as either an AP STA or a non-AP. The AP 502 may be part of, or affiliated with, an AP MLD 808, e.g., AP1 830, AP2 832, or AP3 834. The STAs 504 may be part of, or affiliated with, a non-AP MLD 809, which may be termed a ML non-AP logical entity. The BSS may be part of an extended service set (ESS), which may include multiple APs, access to the internet, and may include one or more management devices.

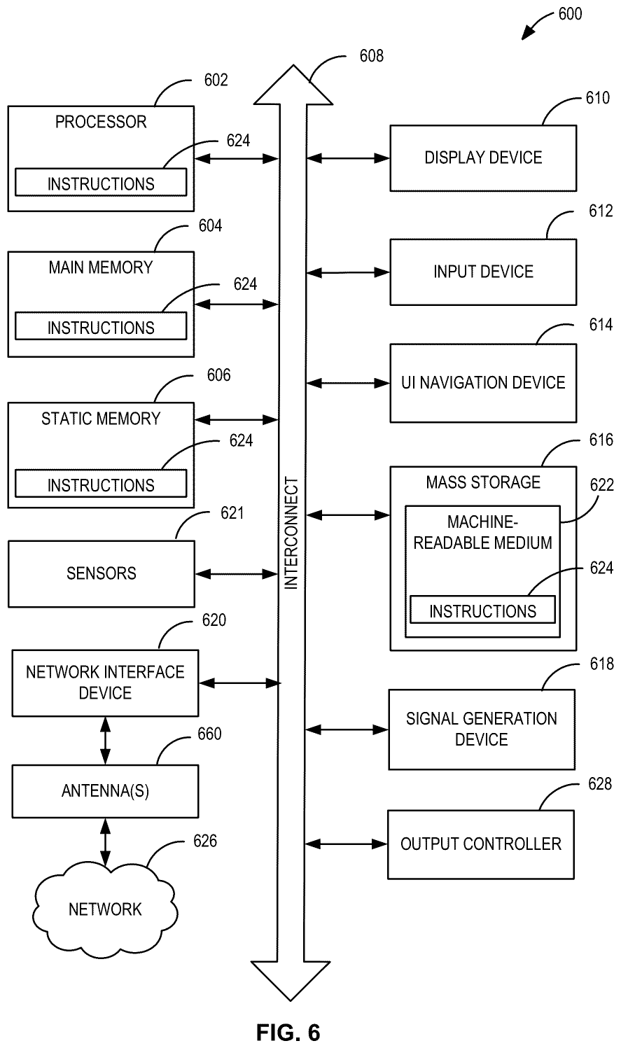

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a HE AP 502, EVT STA 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The mass storage 616 device may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the mass storage 616 device may constitute machine readable media.

Specific examples of machine-readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

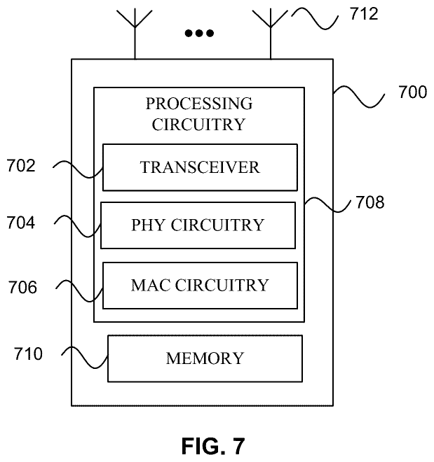

FIG. 7 illustrates a block diagram of an example wireless device 700 upon which any one or more of the techniques (e.g., methodologies or operations) discussed herein may perform. The wireless device 700 may be a HE device or HE wireless device. The wireless device 700 may be a HE STA 504, HE AP 502, and/or a HE STA or HE AP. A HE STA 504, HE AP 502, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., HE AP 502, HE STA 504, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., HE AP 502 and/or HE STA 504), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mm Wave technology, communication between a station (e.g., the HE STAs 504 of FIG. 5 or wireless device 700) and an access point (e.g., the HE AP 502 of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

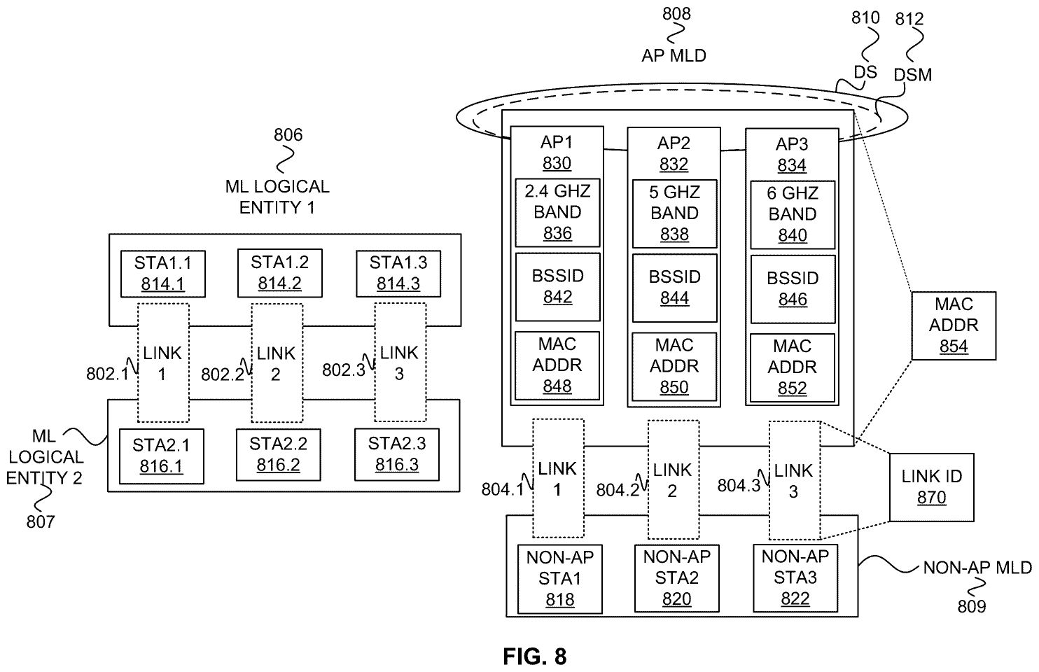

FIG. 8 illustrates multi-link devices (MLD) s 800, in accordance with some embodiments. Illustrated in FIG. 8 is ML logical entity 1 806, ML logical entity 2 807, AP MLD 808, and non-AP MLD 809. The ML logical entity 1 806 includes three STAs, STA1.1 814.1, STA1.2 814.2, and STA1.3 814.3 that operate in accordance with link 1 802.1, link 2 802.2, and link 3 802.3, respectively.

The Links are different frequency bands such as 2.4 GHz band, 5 GHZ band, 6 GHz band, and so forth. ML logical entity 2 807 includes STA2.1 816.1, STA2.2 816.2, and STA2.3 816.3 that operate in accordance with link 1 802.1, link 2 802.2, and link 3 802.3, respectively. In some embodiments ML logical entity 1 806 and ML logical entity 2 807 operate in accordance with a mesh network. Using three links enables the ML logical entity 1 806 and ML logical entity 2 807 to operate using a greater bandwidth and more reliably as they can switch to using a different link if there is interference or if one link is superior due to operating conditions.

The distribution system (DS) 810 indicates how communications are distributed and the DS medium (DSM) 812 indicates the medium that is used for the DS 810, which in this case is the wireless spectrum.

AP MLD 808 includes AP1 830, AP2 832, and AP3 834 operating on link 1 804.1, link 2 804.2, and link 3 804.3, respectively. AP MLD 808 includes a MAC ADDR 854 that may be used by applications to transmit and receive data across one or more of AP1 830, AP2 832, and AP3 834. Each link may have an associated link ID. For example, as illustrated, link 3 804.3 has a link ID 870.

AP1 830, AP2 832, and AP3 834 includes a frequency band, which are 2.4 GHz band 836, 5 GHz band 838, and 6 GHz band 840, respectively. AP1 830, AP2 832, and AP3 834 includes different BSSIDs, which are BSSID 842, BSSID 844, and BSSID 846, respectively. AP1 830, AP2 832, and AP3 834 includes different media access control (MAC) address (addr), which are MAC adder 848, MAC addr 850, and MAC addr 852, respectively. The AP 502 is a AP MLD 808, in accordance with some embodiments. The STA 504 is a non-AP MLD 809, in accordance with some embodiments.

The non-AP MLD 809 includes non-AP STA1 818, non-AP STA2 820, and non-AP STA3 822. Each of the non-AP STAs may have MAC addresses and the non-AP MLD 809 may have a MAC address that is different and used by application programs where the data traffic is split up among non-AP STA1 818, non-AP STA2 820, and non-AP STA3 822.

The STA 504 is a non-AP STA1 818, non-AP STA2 820, or non-AP STA3 822, in accordance with some embodiments. The non-AP STA1 818, non-AP STA2 820, and non-AP STA3 822 may operate as if they are associated with a BSS of AP1 830, AP2 832, or AP3 834, respectively, over link 1 804.1, link 2 804.2, and link 3 804.3, respectively.

A Multi-link device such as ML logical entity 1 806 or ML logical entity 2 807, is a logical entity that contains one or more STAs 814, 816. The ML logical entity 1 806 and ML logical entity 2 807 each has one MAC data service interface and primitives to the logical link control (LLC) and a single address associated with the interface, which can be used to communicate on the DSM 812. Multi-link logical entity allows STAs 814, 816 within the multi-link logical entity to have the same MAC address. In some embodiments a same MAC address is used for application layers and a different MAC address is used per link.

In infrastructure framework, AP MLD 808, includes APs 830, 832, 834, on one side, and non-AP MLD 809, which includes non-APs STAs 818, 820, 822 on the other side.

ML AP device (AP MLD): is a ML logical entity, where each STA within the multi-link logical entity is an EHT AP 502, in accordance with some embodiments. ML non-AP device (non-AP MLD) A multi-link logical entity, where each STA within the multi-link logical entity is a non-AP EHT STA 504. AP1 830, AP2 832, and AP3 834 may be operating on different bands and there may be fewer or more APs. There may be fewer or more STAs as part of the non-AP MLD 809.

In some embodiments the AP MLD 808 is termed an AP MLD or MLD. In some embodiments non-AP MLD 809 is termed a MLD or a non-AP MLD. Each AP (e.g., AP1 830, AP2 832, and AP3 834) of the MLD sends a beacon frame that includes: a description of its capabilities, operation elements, a basic description of the other AP of the same MLD that are collocated, which may be a report in a Reduced Neighbor Report element or another element such as a basic multi-link element. AP1 830, AP2 832, and AP3 834 transmitting information about the other APs in beacons and probe response frames enables STAs of non-AP MLDs to discover the APs of the AP MLD.

In a Wi-Fi network or IEEE 802.11 network, “channel switching” refers to a method where the AP 502 in an infrastructure networks or Group Owner (GO) in peer-to-peer networks determines to transition from a current channel to a new target channel. The AP 502 may determine to switch channels for lots of reasons such as interference.

During channel switching, the clients such as STAs 504 and legacy devices 506 that are associated with the AP 502 on an old channel or original channel often remain associated with the AP 502 on the new channel. The clients are expected to move alongside the GO or AP 502 and maintain uninterrupted communication as if they were still operating on the original channel. The continues uninterrupted communication includes preserving sequence numbers of PPDUs and other relevant contexts.

However, Wi-Fi or IEEE 802.11 bands do not uniformly follow the same rules in terms of the allowed formats and bandwidths that clients can use. For example, in the 2.4 GHz band, a client can utilize the HT format with a bandwidth of 20/40 MHz. In the 5 GHz band, a client can use HT/VHT and HE formats with bandwidths of 20/40/80/160 MHz. In the 6 GHz band, a client is mandated to use HE or EHT (Wi-Fi-7) and can transmit frames using a 320 MHz bandwidth.

Clients associate with APs 502. During the association process, the clients and APs 502 exchange capabilities through an association request frame and an association response frame. The AP 502 may move to another band or target channel and the AP 502 does not know the capabilities of its clients in the target channel. The AP 502 uses the lowest common denominator of client capabilities to communicate with the clients on the target channel, which may be using an HT format, which, often, fails to fully exploit the enhanced potential of the new target band.

IEEE 802.11bk employs 320 MHz bandwidth for ranging. In 6 GHz band, there are incumbent radios that 802.11 devices may need to honor by puncturing subchannels within the 320 MHz band. There are 25 puncturing patterns defined by 802.11be. Due to the implementation complexity, some categories of ranging devices may not support all 25 patterns. We address this problem in this disclosure.

In some embodiments, IEEE 802.11 communication standards such as IEEE 802.11bk use a 320 MHz bandwidth for ranging. In some of the bands that the IEEE 802.11 wireless devices operate on there are incumbent radios. For example, in a 6 GHz band, there are incumbent radios, and IEEE 802.11 devices, e.g., AP 502 and STA 504, are not supposed to or not permitted to interfere with the incumbent radios by transmitting on the channels or bandwidth that is being used by the incumbent radios. The incumbent radios may be other wireless devices not operating in accordance with IEEE 802.11 communication standards such as radar. The use of the channels or bandwidth may be governed by governmental regulations. One way to not interfere with incumbent radios and still use a 320 MHz bandwidth for ranging is to puncture the subchannels within the 320 MHz band that are being used by the incumbent subchannels. In some examples, there are 25 optional puncturing patterns and three mandatory puncturing patterns defined by IEEE 802.11 communication standards such as IEEE 802.11be. Some devices such as APs 502, STAs 504, and other wireless devices that perform ranging do not support all 25 optional puncturing patterns. In some embodiments, there is more than one mandatory puncturing pattern.

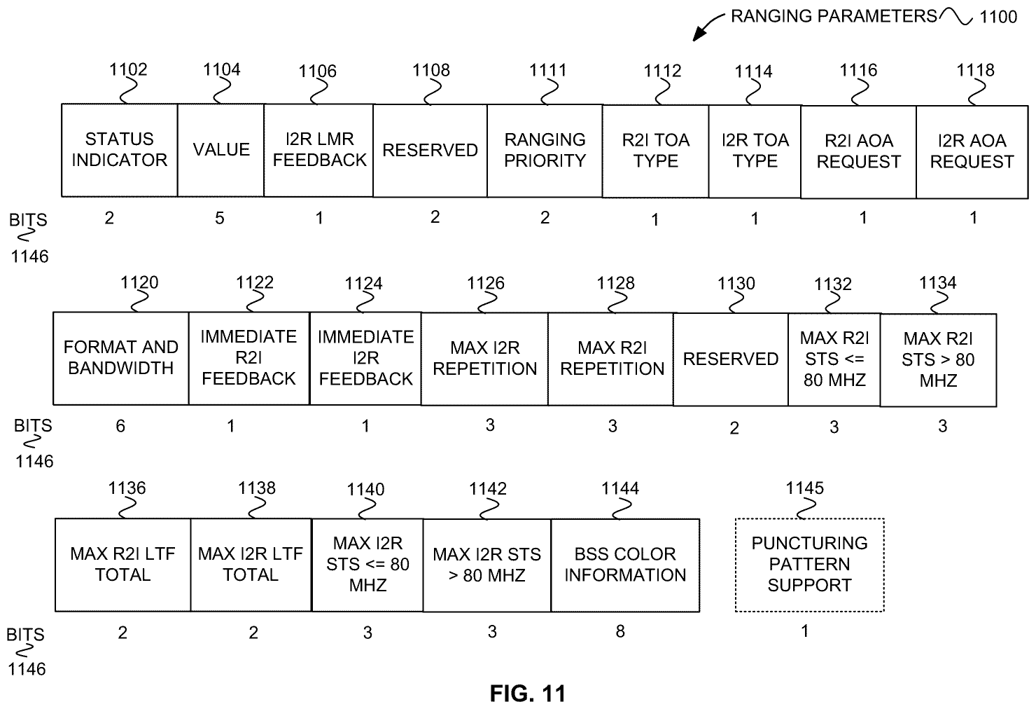

A technical problem is how to signal the puncturing pattern to be used for the ranging operation between the initiator station (ISTA) and the responding station (RSTA). In some embodiments, the technical problem is addressed by utilizing the format and bandwidth 1120 subfield (of FIG. 11). In some embodiments, the technical problem is addressed by creating a new subfield, which may be termed thee puncturing pattern support 1145 subfield. The puncturing pattern support 1145 subfield is formed from one or more bits of the ranging parameters element 1000 and/or bits from the ranging parameters 1010 field such as bits from reserved 1108 or reserved 1130. Reserved 1108 is bit 8, bit 9 and reserved 1130 is bit 30, and bit 31 of the ranging parameters 1100 field. The first value of the first puncturing pattern support 1145 subfield included in the FTMR 1206 frame is greater than or equal to a second value of the second puncturing pattern support 1145 subfield of the IFTM 1210 frame, in accordance with some embodiments. This maintains the order rule where the RSTA 1204 selects parameters for allocation that are indicated with values that are less than or equal to the values used to indicate the requested parameters.

In some embodiments, the puncturing pattern support 1145 subfield is one or more bits of the ranging parameters element 1000 and/or of the format and bandwidth 1120 subfield, with the representation or value of the format and bandwidth being separate from the representation or value of the puncturing pattern support 1145 subfield. The use of the puncturing pattern support 1145 subfield to indicate support for mandatory and/or optional puncturing patterns enables the assignment of values in the format and bandwidth 1120 subfield that maintain an order. The order indicates that when an ISTA 1202 transmits a request for ranging with a value in the format and bandwidth 1120 subfield that the RSTA 1204 can assume that the ISTA 1202 supports the features indicated by all values lower than the value indicated by the ISTA 1202 in the format and bandwidth 1120 subfield of the FTMR 1206 frame. The FTMR 1206 frame may be termed an initial fine timing measurement request (IFTMR) frame.

The format and bandwidth 1120 subfield sent or transmitted by the ISTA 1202 indicates a requested format and a requested bandwidth of 320 MHz bandwidth, in accordance with some embodiments. For example as discussed in conjunction with Table 1. The format and bandwidth 1120 subfield, sent by the RSTA 1204 in response to the format and bandwidth 1120 subfield sent by the ISTA 1202, indicates an allocated format and bandwidth for the 320 MHZ bandwidth, in accordance with some embodiments.

For examples, the puncturing pattern support 1145 subfield is set to 1 to indicate support of all puncturing patterns including both the mandatory and optional puncturing patterns, which may be listed in a Table of the IEEE 802.11 communications standard.

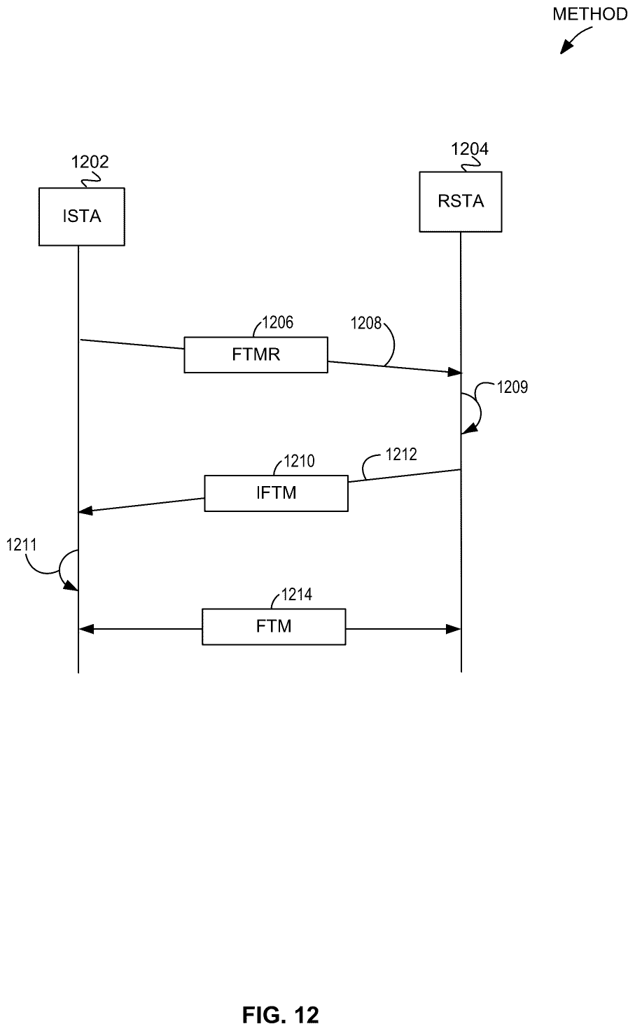

The puncturing pattern support 1145 subfield is set to 0 to indicate support of only the mandatory subset of a set of puncturing patterns, which may be defined in a Table of the IEEE 802.11 communications standard. The puncturing pattern support 1145 subfield is set to 1 to indicate support of an entire set of puncturing patterns, which may be defined in a Table of the IEEE 802.11 communications standard. The ISTA 1202 is requesting 320 MHz ranging with the puncturing pattern support 1145 subfield, in accordance with some embodiments. The RSTA 1204 responds with a value of 0 in the puncturing pattern support 1145 subfield to indicate the mandatory puncturing patterns are allocating for 320 MHz ranging and responds with a to indicate that the optional puncturing patterns are allocated for 320 MHz ranging and, in some embodiments, the value of 1 indicates that both the optional and the mandatory puncturing patterns have been allocated for 320 MHz ranging so the ISTA 1202 may select to use either the optional or mandatory puncturing patterns. In some embodiments, the RSTA 1204 responds with a different field such as the puncturing pattern 1147 field, which is described in conjunction with FIG. 12.

The order enables a quick negotiation of the parameters of a ranging where the RSTA 1204 can select a number, for the IFTM 1210 frame, from the format and bandwidth 1120 subfield equal to or less than the value indicated in the FTMR 1206 frame. Additionally, the negotiation can be facilitated by using a value of 1 (a higher value) for optional puncturing patterns (and mandatory puncturing patterns, since if the STA 504 supports the optional puncturing patterns, the STA 504 also supports the mandatory puncturing patterns 900) and a 0 (a lower value) for only the mandatory puncturing patterns. In this way, again, the RSTA 1204 may pick a number equal to or less than the number indicated by the ISTA 1202 to complete the negotiation for the ranging. Moreover, the negotiation can be facilitated by the ISTA 1202 including the secure long-training (LTF) field or LTF subelement 1013, which may be termed the secure HE-LTF parameters element, or the secure LTF parameters element, in the ranging parameters element 1000 of the FTMR 1206 to indicate a request for secure ranging. The RSTA 1204 then can include the secure LTF subelement 1013 in the ranging parameters element 1000 of the IFTM 1210 to indicate the request for secure ranging is granted or not where including the secure LTF subelement 1013 indicates the request for secure ranging is granted and not including the secure LTF subelement 1013 indicates the request for secure ranging is not granted.

In this way, the format, bandwidth, puncturing pattern, and security of the ranging can often be negotiation with merely two transmissions of the FTMR 1206 and then the response IFTM 1210.

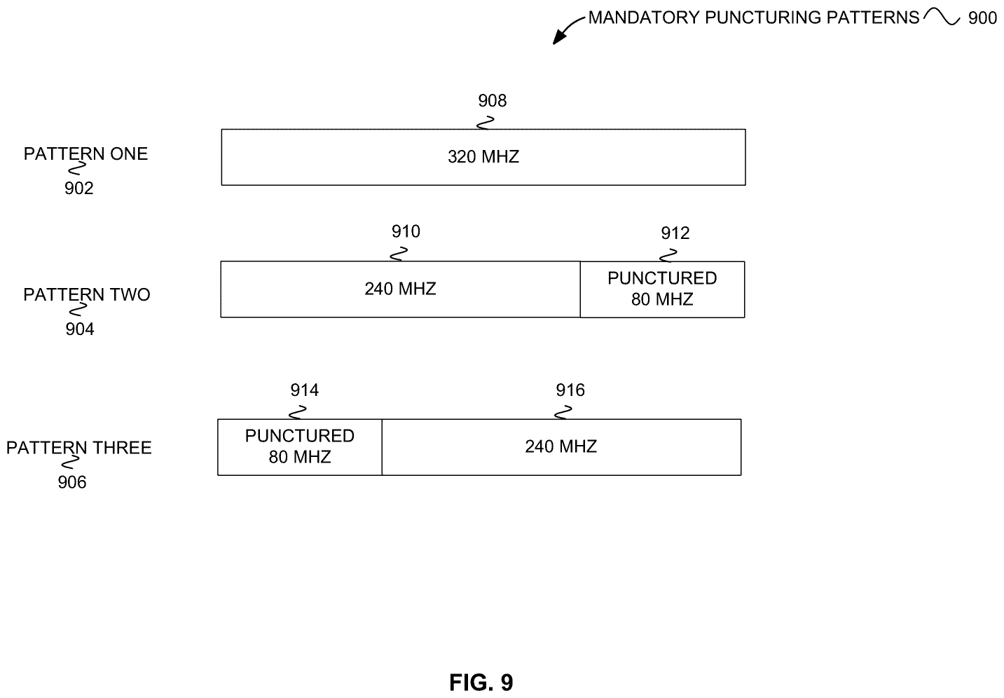

FIG. 9 illustrates mandatory puncturing patterns 900, in accordance with some embodiments. Pattern one 902 is an entire 320 MHz 908 bandwidth without any punctured subchannels. Pattern two 904 is a 240 MHz 910 subchannel and a punctured 80 MHz 912 channel. And pattern three 906 is a punctured 80 MHz 914 subchannel and a 240 MHz 916 channel. Other patterns may be used, in accordance with some examples. The optional pattern set comprises puncturing patterns defined in the communication specification, which include 25 puncturing patterns in accordance with embodiments.

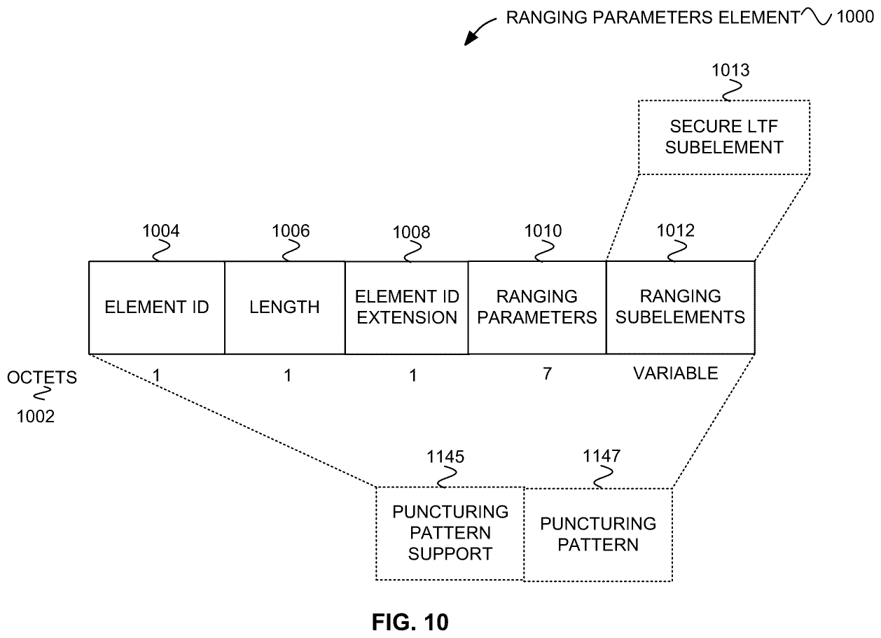

FIG. 10 illustrates the ranging parameters element 1000, in accordance with some embodiments. The fields include an element identification (ID) 1004 field, a length 1006 field, an element ID extension 1008 field, a ranging parameters 1010 field, and a ranging subelements 1012 field. The element ID 1004 field, the length 1006 field, and the element ID extension 1008 field identify the type of element and its length. The octets 1002 indicates the number of octets in each field. The ranging parameters element is included in the one or more frames in ranging such as the request or response frames such as the fine timing measurement request (FTMR), the initial fine timing measurement (IFTM), or another frame.

In ranging, the ISTA and RSTA can select between secure and non-secure ranging using mandatory and optional puncturing pattern sets, respectively. In some embodiments, There are four types of ranging service defined as follows: non-secure ranging with optional puncturing patterns, secure ranging with optional puncturing patterns, non-secure ranging with mandatory puncturing patterns, and secure ranging with mandatory puncturing patterns.

In the negotiation for the parameters to use for ranging, the selection of non-secure and secure ranging is nonnegotiable. For example, if the initiating STA (ISTA) requests secure ranging in the Fine Timing Measurement Request (FTMR) frame and the responding STA (RSTA) doesn't support secure ranging, then the RSTA shall not or will not overwrite the request by granting non-secure ranging in the initial FTM (IFTM) frame as the response to the request.

In contrast, the optional and mandatory puncturing pattern sets may be negotiable. For example, the ISTA requests the optional puncturing pattern set and the RSTA only supports the mandatory set, then the RSTA may overwrite the request by granting mandatory puncturing pattern set for the subsequent ranging measurements as the response to the request. In some embodiments, the puncturing pattern set may be negotiable. In another embodiment, the puncturing pattern set may be nonnegotiable or unnegotiable.

In some embodiments, after the negotiation and during the measurement phase of the ranging session, the ISTA and RSTA are permitted to use only one puncturing pattern out of the agreed or granted puncturing pattern set for 320 MHz ranging. This may be termed static puncturing. In some embodiments, if the ranging STAs using different puncturing patterns out of the granted puncturing pattern set during the ranging session for 320 MHz ranging, this is termed dynamic puncturing. In some embodiments, the ISTA and RSTA are required to support static puncturing as a mandatory mode.

FIG. 11 illustrates a ranging parameters 1100 field, in accordance with some embodiments. FIG. 12 illustrates a method 1200 for indicating puncturing patterns, in accordance with some embodiments. The bits 1146 indicate the number of bits of the fields or subfields, in accordance with some embodiments. The method 1200 illustrates a negotiation phase of a fine timing measurement (FTM) procedure. The FTM procedure enables the ISTA 1202 to determine its distance from the RSTA 1204. The ranging parameters element 1000 contains subfields that are used to advertise the requested or allocated FTM configuration from one STA to another.

The fields include status indicator 1102, value 1104, I2R LMR feedback 1106, reserved 1108, ranging priority 1111, R2I TOA type 1112, I2R TOA type 1114, R2I AOA request 1116, I2R AOA request 1118, format and bandwidth 1120, immediate R2I feedback 1122, immediate I2R feedback 1124, max I2R repetition 1126, max R2I repetition 1128, reserved 1130, max R2I STS<=80 MHz 1132, max R2I STS>80 MHz 1134, max R2I LTF total 1136, max I2R LTF total 1138, max I2R STS<=80 MHz 1140, max I2R STS>80 MHz 1142, and BSS color information 1144. The fields may be as described in one or more of the IEEE 802.11 standards, in accordance with some embodiments.

The ISTA 1202 and RSTA 1204 may be STA 504, AP 502, legacy device 506, STA of a non-AP MLD 809, or an AP of an AP MLD 808, in accordance with some embodiments. The values in the FTMR 1206 frame may be termed requested as they represent requested parameters for a FTM method. The values in the IFTM 1210 may be termed allocated as they are in response to the requested parameters and indicate the RSTA 1204 is prepared to conduct a FTM 1214 procedure or method with the ISTA 1202 based on the values in the IFTM 1210. The ISTA 1202 may restart the negotiations if the values in the IFTM 1210 for a FTM 1214 method are not acceptable.

During the ranging negotiation, the ISTA 1202 sends 1208 the ranging request by an FTMR 1206 frame and the RSTA 1204 responds to the request by sending 1212 or transmitting an IFTM 1210 frame. Both the FTMR 1206 frame and the IFTM 1210 frame include the ranging parameters element 1000. The ranging parameters 1010 field is the same or similar as the ranging parameters 1100 field of FIG. 11. The IFTM 1210 frame includes the puncturing pattern 1147 field, which is used by the RSTA 1204 to convey the disabled subchannel bitmap to the ISTA 1202. The puncturing pattern 1147 field indicates the allocated or agreed upon resources from the RSTA 1204 in response to the ISTA 1202. The puncturing pattern 1147 field indicates a puncturing pattern for 320 MHz ranging, in accordance with some embodiments. For example, Table 2 indicates values that indicate a 320 MHz ranging for a secure fine timing measurement (FTM) session. The puncturing pattern 1147 field is a bitmap with 16 bits, where each bit indicates whether the corresponding 20 MHz subchannel is punctured or not, in accordance with some embodiments.

At operation 1209, the RSTA 1204 determines the parameters for the IFTM 1210 frame response. At operation 1211, the ISTA 1202 determines whether the parameters in the IFTM 1210 frame are acceptable to perform a FTM 1214 method or not.

Values for the format and bandwidth 1120 subfield in the ranging parameters 1100 field are illustrated in Table 1. The format and bandwidth 1120 subfield indicates the selected puncturing pattern sets and their optional puncturing set, in accordance with some embodiments.

TABLE 1
Format and Bandwidth Subfield

| Field value | Format | Bandwidth |
|---|---|---|
| 0 | HE | 20 |
| 1 | HE | 40 |
| 2 | HE | 80 |
| 3 | HE | 80 + 80 |
| 4 | HE and two separate radio frequency | 160 |
| | (RF) local oscillators (LOs) | |
| 5 | HE and a single RF LO | 160 |
| 6-63 | Reserved | Reserved |

In some embodiments, the format and bandwidth 1120 subfield is bits B16 through B21 (with the bit numbering starting with B0). In some embodiments, the puncturing pattern support 1145 subfield is one or more bits of B19, B20, and B21 of the format and bandwidth 1120 subfield. In some embodiments, two reserved field values in Table 1 are used to indicate the mandatory and optional puncturing pattern sets. In a first example, field values 6 and 7 may be used to indicate the support of a mandatory puncturing pattern set and an optional puncturing pattern set, respectively. In a second example, field values 6 and 7 indicate the support of an optional puncturing pattern set and a mandatory puncturing pattern set, respectively.

In some embodiments, the first example may be preferable over the second. In some examples, a convention in Table 1 is that if the RSTA 1204 cannot agree with the field value indicated in Table 1 requested by the ISTA 1202 (in the FTMR 1206 frame), a smaller value can be granted by the RSTA 1204 in the IFTM 1210. In the first example, if the ISTA 1202 signaled value 7, then the RSTA 1204 can assign the ISTA value 6 because the mandatory puncturing set is a subset of the optional puncturing set. In contrast, the second example does not follow this convention because the optional puncturing set is not a subset of the mandatory puncturing set.

In some embodiments, the entries of the format and bandwidth 1120 field have an order. For example, referring to Table 1, value of 0 (20 MHz HE)<value of 1 (40 MHz HE)<value of 2 (80 MHz), and so on. In some examples, this property is used during the negotiation. If the ISTA 1202 signaled vale N, it means it supports all values smaller than N with smaller bandwidths and thus the RSTA 1204 can assign the ISTA 1202 a lower value from Table 1 in the format and bandwidth 1120 field of the IFTM 1210 frame. For example, if the ISTA 1202 sends 1208 a value 5, then the ISTA 1202 supports values 2, 1, and 0 of Table 1. However, values 4 and 3 may be not supported because the values 3, 4, 5 share the same bandwidth but the implementations can be quite different. In some examples, ISTAs 1202 and RSTAs 1204 that support value 4 should be fine with value 5 but not the other way around.

To maintain the order, values 7 and 6 are used to indicate optional and mandatory puncturing pattern sets, respectively. However, this may still not strictly maintain the order and may cause uncertainty. For a given value N for a larger bandwidth, if there are multiple exclusive options for a smaller bandwidth and the RSTA 1204 does not support the larger bandwidth, then the RSTA 1204 does not know which option to choose for the smaller bandwidth. For example, if the ISTA 1202 requested value 7 for 320 MHz ranging but the RSTA 1204 can only do 160 MHz ranging, then the RSTA 1204 does not know which option out of values 3, 4, and 5 from which to choose for the 160 MHz ranging because the ISTA 1202 did not provide any information about its support for 160 MHz options. In this example, the negotiation may fail and the ISTA 1202 may need to do another round of negotiation.

In some examples, to remove the uncertainty about the smaller bandwidth, more entries are added to Table 1. The uncertainty comes from the multiple options for 160 MHz and 320 MHz, respectively. We need to enumerate the supported combinations of 160 and 320 MHz in the format and bandwidth 1120 subfield such that a single value can clearly indicate the device's capability for all bandwidths, i.e., 320 MHz, 160 MHz, and the smaller ones. This enables the RSTA 1204 to select a value from Table 1 that is smaller than the value indicated by the ISTA 1202 from Table 1 if the RSTA 1204 does not support the value from Table 1 sent 1208 in the format and bandwidth 1120 field of the FTMR 1206 frame

ISTAs 1202 and RSTAs 1204 that support 160 MHz and 320 MHz normally support 80 MHz, 40 MHz, and 20 MHz. One example is shown in Table 1. It should be noticed that we may not need to add all the 6 combinations because the “two separate RF LOs for 160” was initially for included into the spec for MediaTek's poor implementation and it is not needed now after MediaTek's implementation improved. Therefore, we may only need to add 4 entries instead of 6 to the table of the Format and Bandwidth Subfield.

To remove the uncertainty about the smaller bandwidth, additional entries are added to Table 1. The uncertainty comes from the multiple options for 160 MHz and 320 MHz, respectively. Some embodiments enumerate the supported combinations of 160 and 320 MHz in the format and bandwidth 1120 subfield as illustrated in Table 2. A single field value can indicate capability for all bandwidths for the ISTA 1202 or the RSTA 1204 where the bandwidths include 320 MHz, 160 MHz, and the smaller bandwidths in Table 1. In some embodiments, an ISTA 1202 or an RSTA 1204 that supports bandwidth of 320 MHz and 160 MHz typically support 80 MHz, 40 MHz, and 20 MHz. Table 2 illustrates an example assignment of the field values to formats and bandwidth for the format and bandwidth 1120 field. The column “two RF LOs” indicate rows with an X that may be excluded if implementations of the ISTA 1202 and RSTA 1204 do not include “two RF LOs.”

The actual hardware used for the ISTA 1202 and RSTA 1204 is not fixed. So, in some examples, only 4 additional entries are added to Table 1 instead of the six illustrated in Table 2. Table 2 is an extension of Table 1, which is the values of the format and bandwidth 1120 subfield.

TABLE 2

| Two | | | |
|---|---|---|---|
| RF | Field | | |
| LOs | value | Format | Bandwidth |
| | . . . | . . . | . . . |
| | 6 | Mandatory puncturing pattern set for 320 | 320, 80 + 80 |
| X | 7 | Mandatory puncturing pattern set for 320, | 320, 160 |
| | | two separate RF LOs for 160 | |
| | 8 | Mandatory puncturing pattern set for 320, | 320, 160 |
| | | single RF LO for 160 | |
| | 9 | Optional puncturing pattern set for 320 | 320, 80 + 80 |
| X | 10 | Optional puncturing pattern set for 320, | 320, 160 |
| | | two separate RF LOs for 160 | |
| | 11 | Optional puncturing pattern set for 320, | 320, 160 |
| | | single RF LO for 160 | |

One skilled in the art will recognize that different field values may be used for the format and bandwidth assignments. For example, a value of 8 may be used to indicate 320 MHz bandwidth. Although using the Format and Bandwidth subfield works roughly for the puncturing pattern set indication or selection, it may cause problems in future implementations. For example, when 480 MHz channels are adapted for ranging, then the format and bandwidth 1120 field will not be large enough to accommodate the new combinations. If the format and bandwidth 1120 field value specifies the pattern set for 480 MHz, then the ISTA 1202 and RSTA 1204 will not have enough bits to indicate their capabilities for 160 MHz and 320 MHz. The ISTA 1202 and RSTA 1204 would need to enumerate the capability combinations for 160 MHz, 320 MHz, and 480 MHz in the format and bandwidth 1120 field table.

In some embodiments, reserved 1108, 1130 bits are used in the ranging parameters element 1000. The reserved 1108, 1130 bits are defined as a subfield for indicating the puncturing pattern set as either mandatory puncturing pattern or optional puncturing pattern. The ISTA 1202 and RSTA 1204 use the ranging parameters element 1000 is used with and without the secured HE-LTF parameters element. In some examples, the bit for the new subfield is set to 0 for the mandatory puncturing patterns 900 and 1 for the optional puncturing patterns (not illustrated). For example, the puncturing pattern support 1145 subfield may indicate mandatory puncturing patterns 900, e.g., 0 or 1, and may indicate optional puncturing patterns, e.g., 1 or 0. The use of the puncturing pattern support 1145 subfield may be used for a 320 MHz bandwidth and also future bandwidths like 480 MHz or 640 MHz. In some embodiments, puncturing pattern support 1145 subfield is one or more of the bits from reserved 1108, 1130. In some embodiments, puncturing pattern support 1145 subfield is two or more bits with values to select an optional puncturing pattern set from multiple optional puncturing pattern sets. To maintain the order where lower numbers can be selected by the RSTA 1204 (as the ISTA 1202 is assumed to supported features indicated by lower values), a value of 1 for optional puncturing patterns is used and 0 for mandatory puncturing patterns, in accordance with some examples.

In some examples, the selection between secure and non-secure ranging needs is indicated as follows. If the secure LTF subelement 1013 is present in the FTMR 1206, the secure ranging is requested. The secure LTF subelement 1013 is included in the ranging subelements 1012 field of the ranging parameters element 1000 of FIG. 10.

If the secure LTF subelement 1013 is present in the IFTM 1210, then secure ranging is granted by the RSTA 1204. The puncturing pattern set of the selected secure or non-secure ranging is then determined by the indication described previously in the disclosure from either the puncturing pattern support 1145 subfield or the additions to the format and bandwidth 1120 subfield values as illustrated in Table 2.

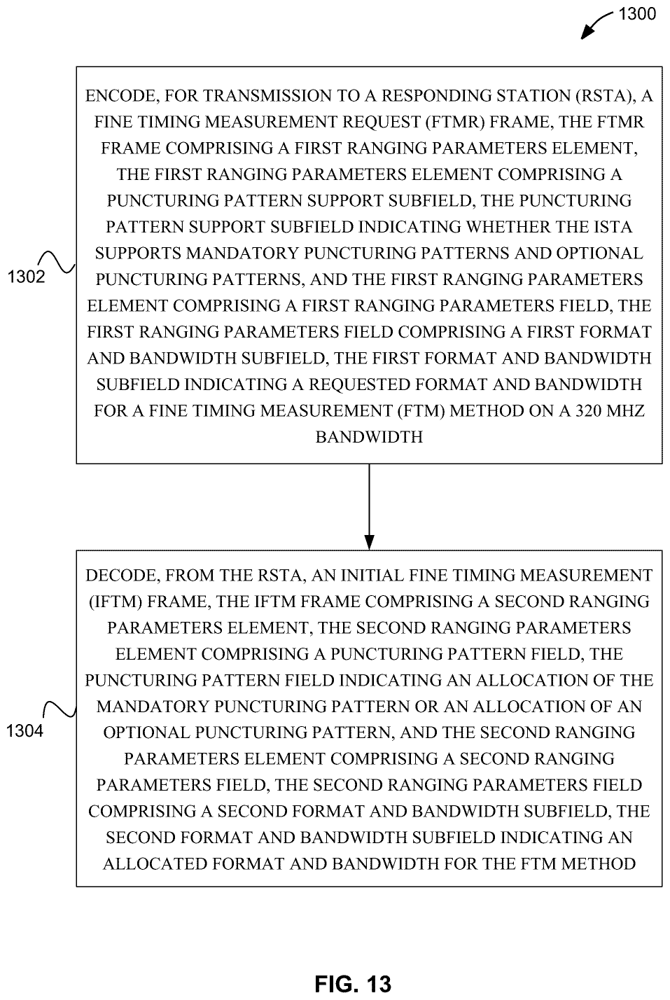

FIG. 13 illustrates a method 1300 for indicating puncturing patterns, in accordance with some embodiments. The method 1300 begins at operation 1302 with encoding, for transmission to a responding station (RSTA), a fine timing measurement request (FTMR) frame, the FTMR frame comprising a first ranging parameters element, the first ranging parameters element comprising a puncturing pattern support subfield, the puncturing pattern support subfield indicating whether the ISTA supports mandatory puncturing patterns and optional puncturing patterns, and the first ranging parameters element comprising a first ranging parameters field, the first ranging parameters field comprising a first format and bandwidth subfield, the first format and bandwidth subfield indicating a requested format and bandwidth for a fine timing measurement (FTM) method on a 320 MHz bandwidth.

For example, the ISTA 1202 encodes the FTMR 1206 comprising a FTMR 1206 frame where the FTMR frame includes a first ranging parameters element 1000 element, the first ranging parameters element 1000 element comprising a puncturing pattern support 1145 subfield, the puncturing pattern support 1145 subfield indicating whether the ISTA 1202 supports mandatory puncturing patterns and optional puncturing patterns, and the first ranging parameters element 1000 comprising a first ranging parameters 1100 field, the first ranging parameters 1100 field comprising a first format and bandwidth 1120 subfield, the first format and bandwidth 1120 subfield indicating a requested format and bandwidth for a fine timing measurement (FTM) method on a 320 MHz bandwidth

The method 1300 continues at operation 1304 with decoding, from the RSTA, an initial fine timing measurement (IFTM) frame, the IFTM frame comprising a second ranging parameters element, the second ranging parameters element comprising a puncturing pattern field, the puncturing pattern field indicating an allocation of the mandatory puncturing pattern or an allocation of an optional puncturing pattern, and the second ranging parameters element comprising a second ranging parameters field, the second ranging parameters field comprising a second format and bandwidth subfield, the second format and bandwidth subfield indicating an allocated format and bandwidth for the FTM method.

For example, the ISTA 1202 decodes the IFTM 1210 frame from the RSTA 1204, the IFTM 1210 frame including a second ranging parameters element 1000 element, the second ranging parameters element 1000 element comprising a puncturing pattern support 1145 field, the puncturing pattern support 1145 field indicating an allocation of the mandatory puncturing pattern or an allocation of an optional puncturing pattern, and the second ranging parameters element comprising a second ranging parameters 1010 field, the second ranging parameters field comprising a second format and bandwidth subfield, the second format and bandwidth 1120 subfield indicating an allocated format and bandwidth for the FTM method.

The method 1300 may be performed by an apparatus for a STA 504, an apparatus of a non-AP MLD 809, an apparatus of an AP 502, or an apparatus of an AP MLD 808, and/or another device or apparatus disclosed herein, which may be termed ISTAs. The method 1300 may include one or more additional instructions. The method 1300 may be performed in a different order. One or more of the operations of method 1300 may be optional.

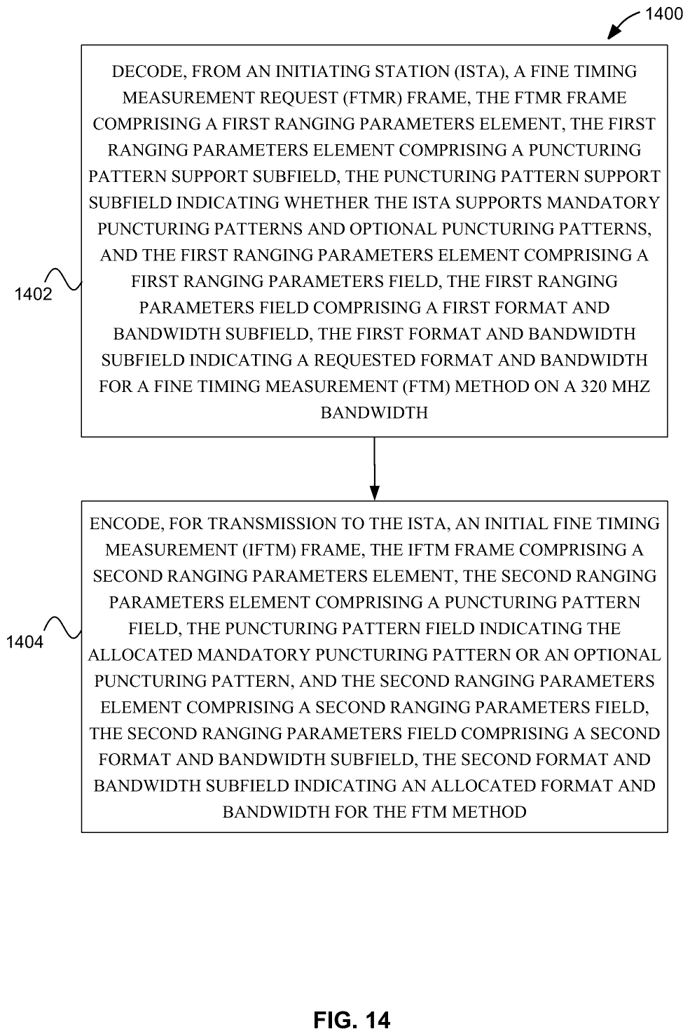

FIG. 14 illustrates a method 1400 for indicating puncturing patterns, in accordance with some embodiments. The method 1400 begins at operation 1402 with decoding, from an initiating station (ISTA), a fine timing measurement request (FTMR) frame, the FTMR frame comprising a first ranging parameters element, the first ranging parameters element comprising a puncturing pattern support subfield, the puncturing pattern support subfield indicating whether the ISTA supports mandatory puncturing patterns and optional puncturing patterns, and the first ranging parameters element comprising a first ranging parameters field, the first ranging parameters field comprising a first format and bandwidth subfield, the first format and bandwidth subfield indicating a requested format and bandwidth for a fine timing measurement (FTM) method on a 320 MHz bandwidth.

For example, the RSTA 1204 decodes, from the ISTA 1202, a FTMR 1206 frame, the FTMR 1206 frame comprising a first ranging parameters element 1000, the first ranging parameters element including a puncturing pattern support 1145 subfield, the puncturing pattern support 1145 subfield indicating whether the ISTA 1202 supports mandatory puncturing patterns and optional puncturing patterns, and the first ranging parameters element 1000 comprising a first ranging parameters 1010 field, the first ranging parameters 1010 field comprising a first format and bandwidth 1120 subfield, the first format and bandwidth 1120 subfield indicating a requested format and bandwidth for a fine timing measurement (FTM) method on a 320 MHz bandwidth; and

The method 1400 continues at operation 1404 with encoding, for transmission to the ISTA, an initial fine timing measurement (IFTM) frame, the IFTM frame comprising a second ranging parameters element, the second ranging parameters element comprising a puncturing pattern field, the puncturing pattern field indicating allocation of mandatory puncturing patterns or optional puncturing patterns, and the second ranging parameters element comprising a second ranging parameters field, the second ranging parameters field comprising a second format and bandwidth subfield, the second format and bandwidth subfield indicating an allocated format and bandwidth for the FTM method.

For example, the RSTA 1204 responds to the FTMR 1206 by encoding, for transmission to the ISTA 1202, the IFTM 1210 frame, the IFTM 1210 frame including a second ranging parameters element 1000, the second ranging parameters element 1000 comprising a puncturing pattern support 1145 field, the puncturing pattern field indicating the allocated mandatory puncturing pattern or an optional puncturing pattern, and the second ranging parameters element comprising a second ranging parameters 1010 field, the second ranging parameters 1010 field comprising a second format and bandwidth 1120 subfield, the second format and bandwidth 1120 subfield indicating an allocated format and bandwidth for the FTM method.

The method 1400 may be performed by an apparatus for a STA 504, an apparatus of a non-AP MLD 809, an apparatus of an AP 502, or an apparatus of an AP MLD 808, and/or another device or apparatus disclosed herein, which may be termed RSTAs. The method 1400 may include one or more additional instructions. The method 1400 may be performed in a different order. One or more of the operations of method 1400 may be optional.

The following are further examples. Example 1 is an apparatus for initiating station (ISTA), the apparatus comprising: memory; and processing circuitry coupled to the memory, the processing circuitry configured to: encode, for transmission to a responding station (RSTA), an initial fine timing measurement request (IFTMR) frame, the IFTMR frame comprising a first ranging parameters element, the first ranging parameters element comprising a puncturing pattern support subfield, the puncturing pattern support subfield indicating whether the ISTA supports all puncturing patterns of a set of puncturing patterns or a subset of the puncturing patterns, and the first ranging parameters element comprising a first ranging parameters field, the first ranging parameters field comprising a first format and bandwidth subfield, the first format and bandwidth subfield indicating a requested format and a requested bandwidth of 320 MHz bandwidth; and
decode, from the RSTA, an initial fine timing measurement (IFTM) frame, the IFTM frame comprising a second ranging parameters element, the second ranging parameters element comprising a puncturing pattern field, the puncturing pattern field indicating a puncturing pattern for 320 MHz ranging, and the second ranging parameters element comprising a second ranging parameters field, the second ranging parameters field comprising a second format and bandwidth subfield, the second format and bandwidth subfield indicating an allocated format and bandwidth for the 320 MHz bandwidth.

Example 2, includes an apparatus of example 1, wherein the processing circuitry is further configured to: encode the IFTMR frame to further comprise a secure long-training field (LTF) subelement to indicate a request for a secure LTF measurement exchange mode with the RSTA. Example 3 includes an apparatus of example 2, wherein the secure LTF subelement is a first secure LTF subelement, and wherein the IFTM further comprises a second secure LTF subelement to indicate a secure fine timing measurement (FTM) session where secure LTF will be used.

Example 4 includes an apparatus of example, 1, wherein the first format and bandwidth subfield indicates a value of 8. Example 5 includes an apparatus of example 1, wherein the second format and bandwidth subfield indicates a value of 8. Example 6 includes an apparatus of example, 1, wherein a first value of the first format and bandwidth subfield is greater than or equal to a second value of the second format and bandwidth subfield.

Example 7 includes an apparatus of example 1, wherein a first value of the first format and bandwidth subfield indicates the requested format and bandwidth, and wherein a second value, of the second format and bandwidth subfield, indicates the allocated format and bandwidth.

Example, 8 includes an apparatus of example 1, wherein the first format and bandwidth subfield further indicates support for an extremely high-throughput (EHT) communication standard. Example 9 includes an apparatus of example 1, wherein the puncturing pattern field is separate from the second format and bandwidth subfield. Example 10 includes an apparatus of example 1, wherein the puncturing pattern support subfield is separate from the first format and bandwidth subfield. Example 11 includes an apparatus of example 1, wherein the processing circuitry is further configured to: perform a fine timing measurement (FTM) session with the RSTA in accordance with the puncturing pattern for 320 MHz ranging and the allocated format and bandwidth for the 320 MHz bandwidth.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1-20. (canceled)

21. An apparatus for initiating station (ISTA), the apparatus comprising: memory; and processing circuitry coupled to the memory, the processing circuitry configured to:
encode, for transmission to a responding station (RSTA), an initial fine timing measurement request (IFTMR) frame, the IFTMR frame comprising a first ranging parameters element, the first ranging parameters element comprising a puncturing pattern support subfield, the puncturing pattern support subfield indicating whether the ISTA supports all puncturing patterns of a set of puncturing patterns or a subset of the set of puncturing patterns, and the first ranging parameters element comprising a first ranging parameters field, the first ranging parameters field comprising a first format and bandwidth subfield, the first format and bandwidth subfield indicating a requested format and a requested bandwidth of 320 MHz; and
decode, from the RSTA, an initial fine timing measurement (IFTM) frame, the IFTM frame comprising a second ranging parameters element, the second ranging parameters element comprising a puncturing pattern field, the puncturing pattern field indicating a puncturing pattern for 320 MHz ranging, and the second ranging parameters element comprising a second ranging parameters field, the second ranging parameters field comprising a second format and bandwidth subfield, the second format and bandwidth subfield indicating an allocated format and bandwidth for the 320 MHz bandwidth.

22. The apparatus of claim 21, wherein the processing circuitry is further configured to:
encode the IFTMR frame to further comprise a secure long-training field (LTF) subelement to indicate a request for a secure LTF measurement exchange mode with the RSTA.

23. The apparatus of claim 22, wherein the secure LTF subelement is a first secure LTF subelement, and wherein the IFTM further comprises a second secure LTF subelement to indicate a secure fine timing measurement (FTM) session where secure LTF will be used.

24. The apparatus of claim 21, wherein the first format and bandwidth subfield has a value of 8 indicating the 320 MHz bandwidth.

25. The apparatus of claim 21, wherein the second format and bandwidth subfield indicates a value of 8.

26. The apparatus of claim 21, wherein a first value of the first format and bandwidth subfield is greater than or equal to a second value of the second format and bandwidth subfield.

27. The apparatus of claim 21, wherein a first value of the first format and bandwidth subfield indicates the requested format and bandwidth, and wherein a second value, of the second format and bandwidth subfield, indicates the allocated format and bandwidth.

28. The apparatus of claim 21, wherein the first format and bandwidth subfield further indicates support for an extremely high-throughput (EHT) communication standard.

29. The apparatus of claim 21, wherein the puncturing pattern field is separate from the second format and bandwidth subfield.

30. The apparatus of claim 21, wherein the puncturing pattern support subfield is separate from the first format and bandwidth subfield.

31. The apparatus of claim 21, wherein the processing circuitry is further configured to:
perform a fine timing measurement (FTM) session with the RSTA in accordance with the puncturing pattern for 320 MHz ranging and the allocated format and bandwidth for the 320 MHz bandwidth.

32. The apparatus of claim 21, wherein the ISTA is affiliated with a first non-access point (AP) multi-link device (MLD) or a first access point (AP) MLD, and wherein the RSTA is affiliated with a second non-AP MLD or a second AP MLD.

33. The apparatus of claim 21, further comprising transceiver circuitry coupled to the processing circuitry, wherein the transceiver circuitry is coupled to two or more microstrip antennas for receiving signaling in accordance with a multiple-input multiple-output (MIMO) technique, or the transceiver circuitry is coupled to the processing circuitry, the transceiver circuitry coupled to two or more patch antennas for receiving signaling in accordance with a multiple-input multiple-output (MIMO) technique.

34. A non-transitory computer-readable storage medium including instructions that, when processed by one or more processors, configure an apparatus of an initiating station (ISTA) to perform operations comprising:
encode, for transmission to a responding station (RSTA), an initial fine timing measurement request (IFTMR) frame, the IFTMR frame comprising a first ranging parameters element, the first ranging parameters element comprising a puncturing pattern support subfield, the puncturing pattern support subfield indicating whether the ISTA supports all puncturing patterns of a set of puncturing patterns or a subset of the set of puncturing patterns, and the first ranging parameters element comprising a first ranging parameters field, the first ranging parameters field comprising a first format and bandwidth subfield, the first format and bandwidth subfield indicating a requested format and a requested bandwidth of 320 MHz; and
decode, from the RSTA, an initial fine timing measurement (IFTM) frame, the IFTM frame comprising a second ranging parameters element, the second ranging parameters element comprising a puncturing pattern field, the puncturing pattern field indicating a puncturing pattern for 320 MHz ranging, and the second ranging parameters element comprising a second ranging parameters field, the second ranging parameters field comprising a second format and bandwidth subfield, the second format and bandwidth subfield indicating an allocated format and bandwidth for the 320 MHz bandwidth.

35. The non-transitory computer-readable storage medium of claim 34, wherein the operations further comprise:
encode the IFTMR frame to further comprise a secure long-training field (LTF) subelement to indicate a request for a secure LTF measurement exchange mode with the RSTA.

36. The non-transitory computer-readable storage medium of claim 35, wherein the secure LTF subelement is a first secure LTF subelement, and wherein the IFTM further comprises a second secure LTF.

37. An apparatus for a responding station (RSTA), the apparatus comprising memory; and processing circuitry coupled to the memory, the processing circuitry configured to:
decode, from an initiating station (ISTA), an initial fine timing measurement request (IFTMR) frame, the IFTMR frame comprising a first ranging parameters element, the first ranging parameters element comprising a puncturing pattern support subfield, the puncturing pattern support subfield indicating whether the ISTA supports all puncturing patterns of a set of puncturing patterns or a subset of the set of puncturing patterns, and the first ranging parameters element comprising a first ranging parameters field, the first ranging parameters field comprising a first format and bandwidth subfield, the first format and bandwidth subfield indicating a requested format and a requested bandwidth of 320 MHz; and
encode, for transmission to the ISTA, an initial fine timing measurement (IFTM) frame, the IFTM frame comprising a second ranging parameters element, the second ranging parameters element comprising a puncturing pattern field, the puncturing pattern field indicating a puncturing pattern for 320 MHz ranging, and the second ranging parameters element comprising a second ranging parameters field, the second ranging parameters field comprising a second format and bandwidth subfield, the second format and bandwidth subfield indicating an allocated format and bandwidth for the 320 MHz bandwidth.

38. The apparatus of claim 37, wherein the IFTMR frame further comprises a secure long-training field (LTF) subelement to indicate a request for a secure LTF measurement exchange mode with the RSTA.

39. The apparatus of claim 38, wherein the secure LTF subelement is a first secure LTF subelement, and wherein the processing circuitry is further configured to:
encode the IFTM to further comprise a second secure LTF subelement to indicate a secure fine timing measurement (FTM) session where secure LTF will be used.

40. The apparatus of claim 37, wherein the first format and bandwidth subfield has a value of 8 indicating the 320 MHz bandwidth.
